(19) United States
(12) Patent Application Publication
(10) Pub. No.: US 2008/0131125 A1
(43) Pub. Date: Jun. 5, 2008

(54) LOOPBACK-TYPE WAVELENGTH DIVISION MULTIPLEXING PASSIVE OPTICAL NETWORK SYSTEM

(76) Inventors: Kim Byoung Whi, Daejeon (KR); Jang Seung Hyun, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/947,692

(22) Filed: Nov. 29, 2007

(30) Foreign Application Priority Data
Dec. 1, 2006 (KR) 10-2006-0120330
Sep. 19, 2007 (KR) 10-2007-0095259

(51) Int. Cl. H04J 14/02

(52) U.S. Cl. 398/72

(57) ABSTRACT

Provided is a loopback-type wavelength division multiplexing passive optical network (WDM-PON) system including: a central office converting downstream signals into downstream optical subcarrier multiplexed (SCM) signals to wavelength-multiplex and transmit the downstream SCM signals, or receiving and demodulating upstream optical on-off keying (OOK) signals to convert the upstream optical OOK signals into upstream signals; a remote node receiving the wavelength-multiplexed downstream optical SCM signals and wavelength-demultiplexing and transmitting the downstream optical SCM signals, or receiving the upstream optical OOK signals and wavelength-multiplexing and transmitting the upstream optical OOK signals; and subscriber interface units dividing the downstream optical SCM signals into first and second optical SCM signals, converting the first optical SCM signals into downstream signals, and modulating the upstream signals to the optical OOK signals by using the second optical SCM signals to transmit the optical OOK signals to the remote node. Accordingly, stable transmission quality can be guaranteed and system implementation costs can be reduced.

### CROSS-REFERENCE TO RELATED APPLICATIONS

This application claims the priority of Korean Patent Application Number 10-2006-120330 filed on Dec. 1, 2006 and the Korean Patent Application Number 10-2007-95259 filed on Sep. 19, 2007, the disclosure of which is incorporated herein by reference.

### BACKGROUND OF THE INVENTION

1. Field of the Invention

The present invention relates to a wavelength division multiplexing passive optical network (WDM-PON), and more particularly, to a loopback-type WDM-PON system.

This work was supported by the IT R&D program of MIC/IITA [2005-S-401-02, Optical Subscriber and Access Network Technology].

2. Description of the Related Art

As a method of providing data services to subscribers over existing telephone wires, xDSL (digital subscriber line) technologies have been developed and widely used. In addition, a method of providing data services over a cable network using coaxial cables has been proposed and developed.

The existing data service technologies can be applied in consideration of Internet traffic currently used by subscribers without significant problems. However, when super high speed services such as work-at-home services, teleconference, high-definition television (HDTV) level high quality images, remote-education, remote diagnosis, and the like are widely provided to general subscribers some time, it is predicted that it is difficult to provide adequate broadband high quality services since their band widths and distances are limited.

As a subscriber access method of providing broadband services that users require, there is an optical network technology, called, a wavelength division multiplexing passive optical network (WDM-PON), which recently has been studied.

The WDM-PON as a next-generation subscriber network for the information society has advantages in that a large amount of information can be provided to each subscriber and security can be guaranteed. However, it has to solve the problem in that a light source having a predefined wavelength is needed for each subscriber.

In order to solve the problem of subscriber light source, a loopback-type WDM-PON where downstream optical signal is remodulated to be an upstream signal has been proposed and actively developed.

In the loopback scheme, a central office transmits light along with a downstream signal to a subscriber unit, and the subscriber unit re-modulates the light transmitted from the central office to an upstream signal and transmits the upstream signal to the central office.

In a paper tilted ‘Bidirectional WDM-PON Based on Gain-Saturated Reflective Semiconductor Optical Amplifiers’ (IEEE photonics technology letters, Vol. 17, No. 11, pp. 2462462, November 2005), in order to solve the aforementioned problem, a reflective semiconductor optical amplifier (RSOA) is used.

In this case, an downstream optical signal is directly modulated in an on-off keying (OOK) scheme and transmitted, the RSOA of an subscriber interface unit receives the downstream optical signal and amplifies in a gain saturation region, so that data ‘0’ and ‘1’ of the downstream optical signal is amplified as if all of transmitted data is ‘1’. The downstream optical signal leveled by the RSOA is re-modulated to an upstream OOK signal so as to be transmitted.

However, in this method, since a leveling degree of the downstream optical signal is determined by gain saturation characteristics of the RSOA, the leveling degree affects quality of the re-modulated upstream optical signal.

For example, when power less than incident light power for operating the RSOA in a gain saturation region is received to the RSOA, since the RSOA does not operate in the gain saturation region, the downstream optical signal cannot be leveled. In this case, components of the downstream optical signal remain in the upstream optical signal, so that signal quality is significantly degraded, and according to cases, serious error floor may occur.

In another paper titled ‘A Novel Hybrid WDM/SCM-PON Sharing Wavelength for Up- and Down-Link Reflective Semiconductor Optical Amplifier’ (IEEE photonics technology letters, Vol. 18, No. 3, pp. 502-504, February 2006), a method in which when the downstream optical signal is modulated in the OOK scheme and transmitted, the RSOA of the subscriber interface unit re-modulates and transmits the downstream optical signal modulated in the OOK scheme to a subcarrier multiplexed (SCM) signal in a frequency band higher than an upstream OOK signal frequency band, is proposed.

However, the RSOA has to be modulated to the SCM signal in the frequency band higher than the upstream OOK signal frequency band, so that 3 dB modulation bandwidths of the RSOAs of all subscriber interface units have to include the SCM signal frequency band. Therefore, the RSOA having a high 3 dB modulation bandwidth is needed.

In another paper titled ‘WDM Passive Optical Network With Subcarrier Transmission and Baseband Detection Scheme for Laser-Free Subscriber interface units’(IEEE photonics technology letters, Vol. 18, No. 11, pp. 1279-1281, June 2006), a method of transmitting a downstream signal in the SCM scheme and transmitting an upstream signal in the OOK scheme is proposed. In this method, there is a problem in that an expensive apparatus such as a Mach-Zehnder modulator used for the central office and the subscriber interface unit is needed.

### SUMMARY OF THE INVENTION

As described above, a conventional loopback-type wavelength division multiplexing passive optical network (WDM-PON) system has problems in that transmission quality cannot be stably guaranteed and high system implementation costs are required.

According to an aspect of the present invention, there is provided a loopback-type WDM-PON system including: a central office converting downstream signals into downstream optical subcarrier multiplexed (SCM) signals to wavelength-multiplex and transmit the downstream SCM signals, or receiving and demodulating upstream optical on-off keying (OOK) signals to convert the upstream optical OOK signals into upstream signals; a remote node receiving the wavelength-multiplexed downstream optical SCM signals and wavelength-demultiplexing and transmitting the downstream optical SCM signals, or receiving the upstream optical OOK signals and wavelength-multiplexing and transmitting the upstream optical OOK signals; and subscriber interface units dividing the downstream optical SCM signals into first and second optical SCM signals, converting the first optical SCM signals into downstream signals, and modulating the upstream signals to the optical OOK signals by using the second optical SCM signals to transmit the optical OOK signals to the remote node.

In the above aspect of the present invention, the central office may include: frequency up converters modulating the downstream signals into downstream SCM signals; light sources modulating the downstream SCM signals into the downstream optical SCM signals having unique wavelengths; a first optical wavelength multiplexer wavelength-multiplexing and transmitting the downstream optical SCM signals; a first optical wavelength demultiplexer wavelength-demultiplexing the wavelength-multiplexed upstream OOK signals into the upstream optical OOK signals; first optical receivers converting the upstream optical OOK signals into the upstream signals; and first low pass filters removing SCM signal components remaining in the upstream signals.

In addition, the central office may further include a first circulator transmitting the wavelength-multiplexed downstream optical SCM signal to the remote node and transmitting the multiplexed upstream OOK signal to the optical wavelength demultiplexer.

In addition, the central office may include: single mode laser diodes generating seed light sources having unique wavelengths; a second optical wavelength multiplexer wavelength-multiplexing and outputting the seed light sources; second frequency up converters modulating the downstream signals into downstream SCM signals; second reflective semiconductor optical amplifiers (RSOAs) receiving the seed light sources and modulating the downstream SCM signals to the downstream optical SCM signals having unique wavelengths; a second optical wavelength multiplexer/demultiplexer wavelength-demultiplexing the wavelength-multiplexed seed light sources to the seed light sources so as to be provided to the RSOAs, and wavelength-multiplexing and transmitting the downstream optical SCM signals; a second optical wavelength demultiplexer wavelength-demultiplexing the wavelength-multiplexed upstream optical OOK signals into the upstream optical OOK signals; a plurality of second optical receivers demodulating the upstream optical OOK signals into the upstream signals; and a plurality of second low pass filters removing SCM signal components remaining at the upstream signals. In some cases, the central office may further include a second circulator transmitting the wavelength-multiplexed downstream optical SCM signal to the remote node and transmitting the wavelength-multiplexed upstream optical OOK signals to the optical wavelength demultiplexer.

In addition, the remote node may include an optical wavelength multiplexer/demultiplexer wavelength-demultiplexing the wavelength-multiplexed downstream optical SCM signal to the downstream optical SCM signals to transmit the downstream optical SCM signals to the subscriber interface units, and wavelength-multiplexing and transmitting the upstream optical OOK signals to the central office. In some cases, the remote node may further include a third circulator transmitting the wavelength-multiplexed downstream optical SCM signal to the optical wavelength multiplexer/demultiplexer, or transmitting the wavelength-multiplexed upstream optical OOK signal to the central office. In addition, the remote node may further include first couplers dividing and transmitting the downstream optical SCM signals output from the optical wavelength multiplexer/demultiplexer into two signals, or transferring the upstream optical OOK signals output from the subscriber interface units to the optical wavelength multiplexer/demultiplexer.

In addition, each of the subscriber interface units may include: a second coupler dividing the downstream optical SCM signal transmitted from the remote node into first and second optical SCM signals; a second optical receiver converting the first optical SCM signal to an SCM signal; a frequency down converter converting the SCM signal to the downstream signal; and an RSOA generating the upstream signal by using the second optical SCM signal as the seed light source to transmit the upstream signal to the remote node.

According to another aspect of the present invention, there is provided an subscriber interface unit including: a coupler dividing a downstream optical SCM signal transmitted from the remote node into first and second optical SCM signals; an optical receiver converting the first optical SCM signal to an SCM signal; a frequency down converter converting the SCM signal to a downstream signal; and an RSOA generating an upstream signal by using the second optical SCM signal as a seed light source.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a structural view illustrating a loopback-type WDM-PON system according to a first embodiment of the present invention;

FIG. 2 is a structural view illustrating a loopback-type WDM-PON system according to a second embodiment of the present invention;

FIG. 3 is a structural view illustrating a loopback-type WDM-PON system according to a third embodiment of the present invention;

FIG. 4 is a structural view illustrating a loopback-type WDM-PON system according to a fourth embodiment of the present invention; and

FIG. 5 is a structural view illustrating a loopback-type WDM-PON system according to a fifth embodiment of the present invention.

### DETAILED DESCRIPTION OF THE PREFERRED EMBODIMENT

Exemplary embodiments of the present invention will now be described in detail with reference to the accompanying drawings. In the description, the detailed descriptions of well-known functions and structures may be omitted so as not to hinder the understanding of the present invention.

Like reference numerals designate like elements throughout the specification.

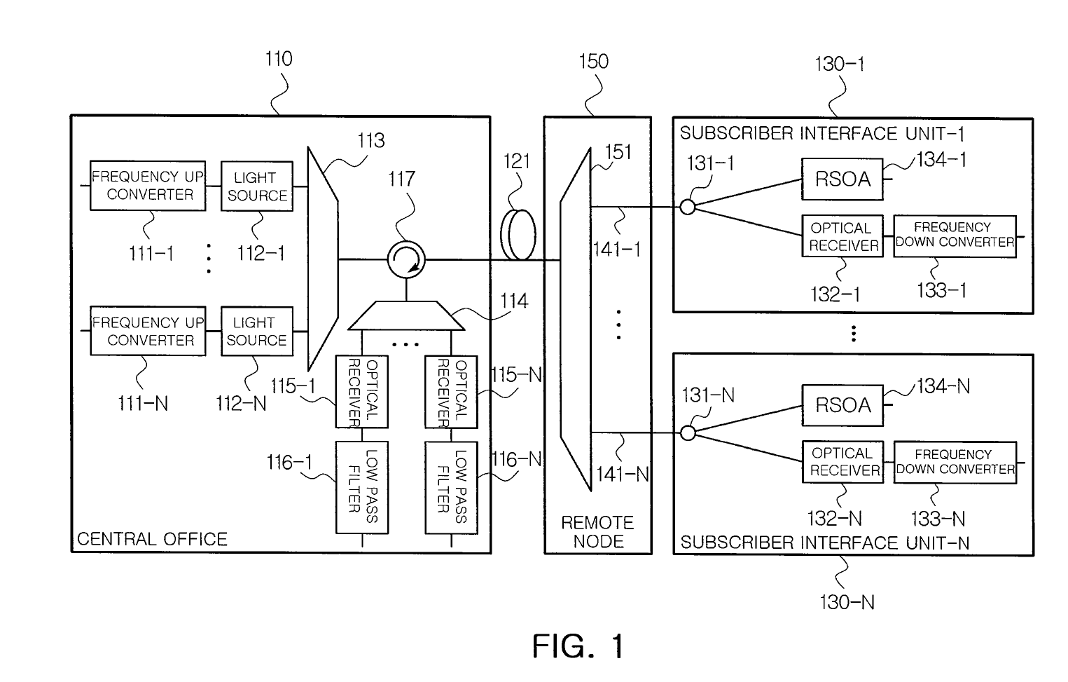

FIG. 1 is a structural view illustrating a loopback-type wavelength division multiplexing passive optical network (WDM-PON) system according to a first embodiment of the present invention.

Referring to FIG. 1, the WDM-PON system according to the first embodiment of the present invention includes a central office 110, a remote node (RN) 150, and N subscriber interface units 130-1 to 130-N. The central office 110 is connected to the remote node 150 through a first optical fiber 121, and the remote node 150 is connected to the N subscriber interface units 130-1 to 130-N through second optical fibers 141-1 to 141-N.

The central office 110 includes N frequency up converters 111-1 to 111-N, N light sources 112-1 to 112-N, an optical wavelength multiplexer 113, an optical wavelength demultiplexer 114, N optical receivers 115-1 to 115-N, N low pass filters 116-1 to 116-N, and a circulator 117.

Each of the frequency up converters 111-1 to 111-N converts a downstream baseband signal into a downstream subcarrier multiplexed (SCM) signal. Each of the light sources 112-1 to 112-N modulates the downstream SCM signal output from a corresponding frequency up converter 111-1 to 111-N to a downstream optical signal having a unique wavelength. The optical wavelength multiplexer 113 wavelength-multiplexes and transmits N downstream optical SCM signals output from the N light sources 112-1 to 112-N to the circulator 117.

Here, the light sources 112-1 to 112-N according to the embodiment of the present invention may be single mode laser diodes (SMLs) such as distributed feedback laser diodes (DFB-LDs) and implemented individually or in an integrated array type. Otherwise, the light sources 112-1 to 112-N may be implemented as an optical module packaged in a transmitter optical CAN (TO CAN) type.

The optical wavelength demultiplexer 114 divides N upstream optical on-off keying (OOK) signals transmitted from the circulator 117 according to wavelengths to transmit the divided signal to each of the N optical receivers 115-1 to 115-N. Each of the optical receivers 115-1 to 115-N converts the input upstream optical OOK signal into an upstream OOK signal, that is, an electric signal. The low pass filters 116-1 to 116-N remove SCM signal components remaining in the upstream OOK signals.

The circulator 117 separates the wavelength-multiplexed downstream optical SCM signals transmitted from the optical multiplexer 113 and wavelength-multiplexed upstream optical OOK signals transmitted from the remote node 150 from each other in order to transmit the wavelength-multiplexed downstream optical SCM signals and the wavelength-multiplexed upstream optical OOK signals to the remote node 150 and the optical demultiplexer 114, respectively.

The remote node 150 includes an optical wavelength multiplexer/demultiplexer 151. The optical multiplexer/demultiplexer 151 wavelength-demultiplexes and transmits the wavelength-multiplexed downstream optical SCM signals transmitted from the circulator in the central office 110 according to wavelengths, to the N subscriber interface units 130-1 to 130-N, or wavelength-multiplexes and transmits the upstream optical OOK signals transmitted from the N subscriber interface units 130-1 to 130-N to the central office 110.

In this case, the N downstream optical SCM signals wavelength-demultiplexed by the optical wavelength multiplexer/demultiplexer 151 are transmitted to the N subscriber interface units 130-1 to 130-N through the N second optical fibers 141-1 to 141-N, and the multiplexed upstream optical OOK signals are transmitted to the central office 110 through the first optical fiber 121.

The subscriber interface unit 130-1 to 130-N includes couplers 131-1 to 131-N, frequency down converters 133-1 to 133-N, and reflective semiconductor optical amplifiers (RSOAs) 134-1 to 134-N.

The coupler 131-1 to 131-N divides a downstream optical SCM signal transmitted from a corresponding second optical fiber 141-1 to 141-N into first and second optical SCM signals. Each of the optical receivers 132-1 to 132-N converts the first optical SCM signal into an electric signal, that is, an SCM signal. Each of the frequency down converters 133-1 to 133-N converts the first SCM signal received from a corresponding optical receiver 132-1 to 132-N to a baseband signal. Each RSOA 134-1 to 134-N re-modulates an upstream baseband signal into an upstream OOK signal by using the second optical SCM signal as a seed light source.

In this case, the SCM signal is not obtained by directly changing a signal level as the OOK signal but is a signal obtained changing a frequency in a frequency modulation method. Therefore, the RSOA 134-1 to 134-N according to the embodiment of the present invention can use the received second SCM signal as the seed light source without an additional signal leveling operation.

In addition, since frequency bands used by the upstream signal and the downstream signal are different from each other, although the downstream optical signal is used as the upstream light, signal interference does not occur. Here, SCM signal components included in the upstream signal have to be removed by the low pass filters 116-1 to 116-N included in the central office 110.

As described above, by modulating and transmitting the downstream signal in the SCM method, the RSOAs 134-1 to 134-N can generate upward signals having stable transmission quality regardless of incident light power.

Now, operations of the WDM-PON illustrated in FIG. 1 are described.

First, the WDM-PON system transmits a baseband signal.

Specifically, a downstream baseband signal to be transmitted to the subscriber interface unit 131-1 to 131-N is converted by the frequency up counter 111-1 to 111-N to a downstream SCM signal, and the downstream SCM signal is modulated by the light source 112-1 to 112-N as a downstream optical SCM signal having a unique wavelength, and the downstream optical SCM signal is wavelength-multiplexed by the optical wavelength-multiplexer 113.

The wavelength-multiplexed downstream optical SCM signal is wavelength-demultiplexed by the optical wavelength multiplexer/demultiplexer 151 so as to be transmitted to a corresponding subscriber interface unit 131-1 to 131-N.

The downstream optical SCM signal input to the subscriber interface unit 131-1 to 131-N is divided into first and second optical SCM signal by the coupler 134-1 to 134-N, and the first optical SCM signal is converted into the original downstream baseband signal by the optical receiver 132-1 to 132-N and the frequency down converter 133-1 to 133-N.

The RSOA 134-1 to 134-N modulates an upstream baseband signal into an upstream optical OOK signal by using the second optical SCM signal as a seed light source.

As described above, after the upstream OOK signal is generated by using the second optical SCM signal, the WDM-PON system according to the embodiment of the present invention transmits the upstream optical OOK signal to the central office 110 by performing the following operations.

The upstream optical OOK signal modulated by using the second optical SCM signal is wavelength-multiplexed by the remote node 150, the wavelength-multiplexed upstream optical OOK signal is wavelength-demultiplexed by the optical wavelength demultiplexer 114 so as to be transmitted to a corresponding optical receiver 115-1 to 115-N.

Thereafter, the upstream optical OOK signal is converted into an upstream OOK signal by the optical receiver 115-1 to 115-N, and SCM signal components remaining in the upstream OOK signal are removed by the low pass filter 116-1 to 116-N.

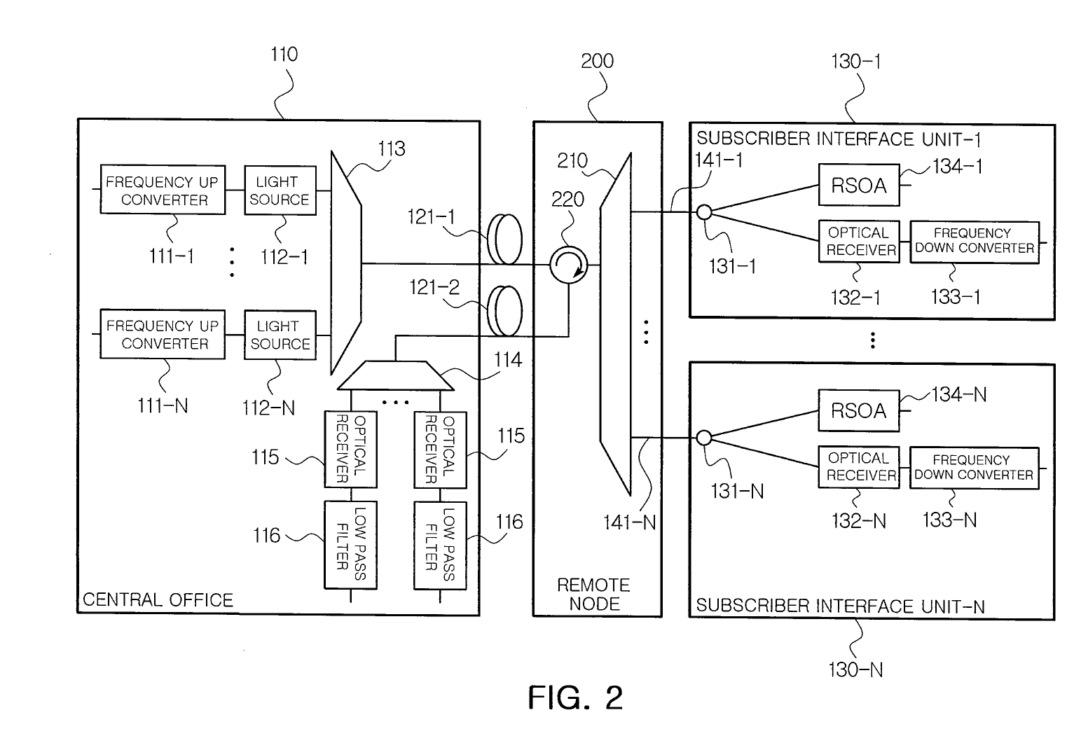

The WDM-PON system illustrated in FIG. 1 as described above may be modified as illustrated in FIGS. 2 to 5.

FIG. 2 is a structural view illustrating a loopback-type WDM-PON system according to a second embodiment of the present invention. The optical fiber of the WDM-PON system of FIG. 2 illustrated in FIG. 1 is modified.

Referring to FIG. 2, a remote node 200 includes a circulator 220 that is included in the central office 110 in FIG. 1, and the first optical fiber 121 is divided into a downstream optical fiber 121-1 and an upstream optical fiber 121-2.

Here, when the wavelength-multiplexed downstream optical SCM signal is transmitted through the downstream optical fiber 121-1, the remote node 200 transmits the received signal to the optical wavelength multiplexer/demultiplexer 210 through the circulator 220. The optical wavelength multiplexer/demultiplexer 210 wavelength-demultiplexes the received signal to N downstream optical SCM signals as illustrated in FIG. 1 and allocate the N downstream optical SCM signals to N second optical fibers 141-1 to 141-N.

When N upstream optical OOK signals are transmitted through the N second optical fibers 141-1 to 141-N, the remote node 200 receives and wavelength-multiplexes the N upstream optical OOK signals through the optical wavelength multiplexer/demultiplexer 210. The wavelength-multiplexed upstream optical OOK signals are output to the upstream optical fiber 121-2 through the circulator 220.

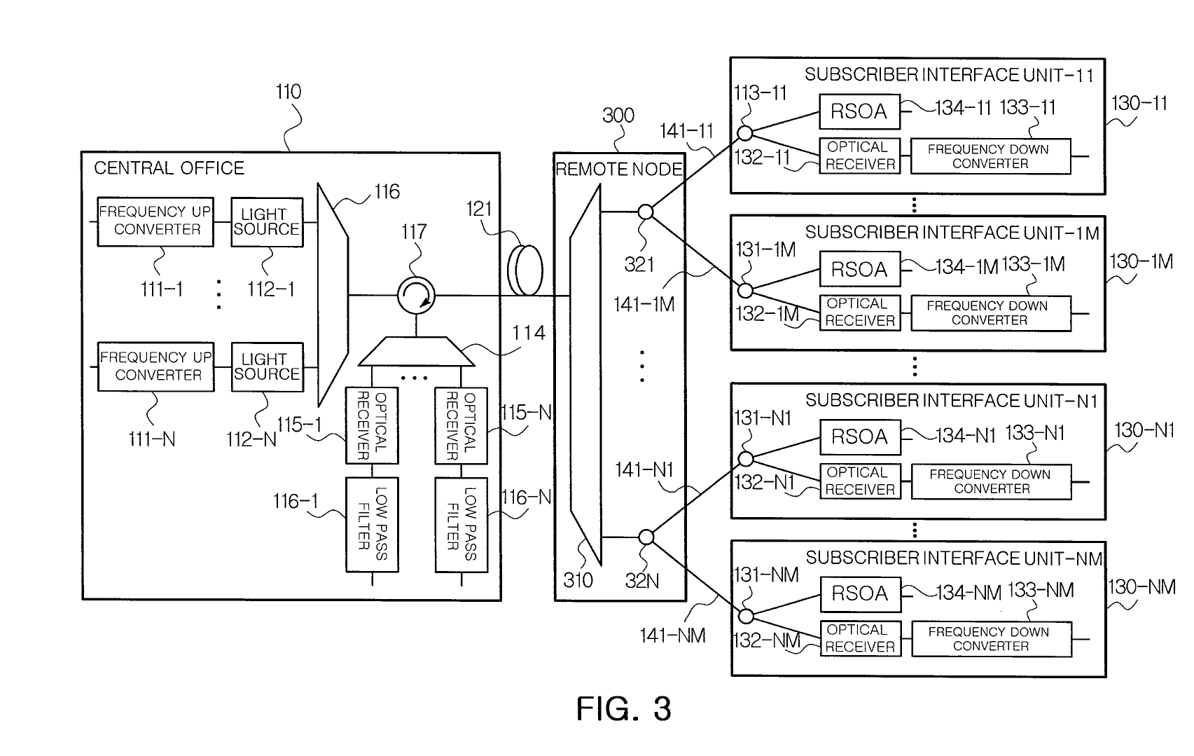

FIG. 3 is a structural view illustrating a loopback-type WDM-PON system according to a third embodiment of the present invention. The loopback-type WDM-PON system in FIG. 3 is used to accommodate a larger number of subscriber interface units.

Referring to FIG. 3, a remote node 300 further includes N splitters 321 to 32N in addition to an optical wavelength multiplexer/demultiplexer 310. The N splitters 321 to 32N divide N downstream optical SCM signals transmitted from the central office 110 into N×M downstream optical SCM signals, or combine N×M upstream optical OOK signals transmitted from N×M subscriber interface units 130-11 to 130-NM into N upstream optical OOK signals by the optical wavelength.

When wavelength-multiplexed downstream optical SCM signals are transmitted from the central office 110 to the remote node 300, the wavelength-multiplexed downstream optical SCM signals are wavelength-demultiplexed to N downstream optical SCM signals by the optical wavelength multiplexer/demultiplexer 310 and divided into N×M downstream optical SCM signals by the N splitters 321 to 32N.

When N×M upstream optical OOK signals are transmitted from the N×M subscriber interface units 130-11 to 130-NM, the N×M upstream optical OOK signals are combined by the N splitters 321-32N of the remote node 300 according to wavelengths, combined into N upstream optical OOK signals, wavelength-multiplexed by the optical wavelength multiplexer/demultiplexer 310, and transmitted to the central office 110.

As described above, the WDM-PON system illustrated in FIG. 3 can accommodate the subscriber interface units 130-11 to 130-NM of which the number is greater than that in the WDM-PON system illustrated in FIG. 1.

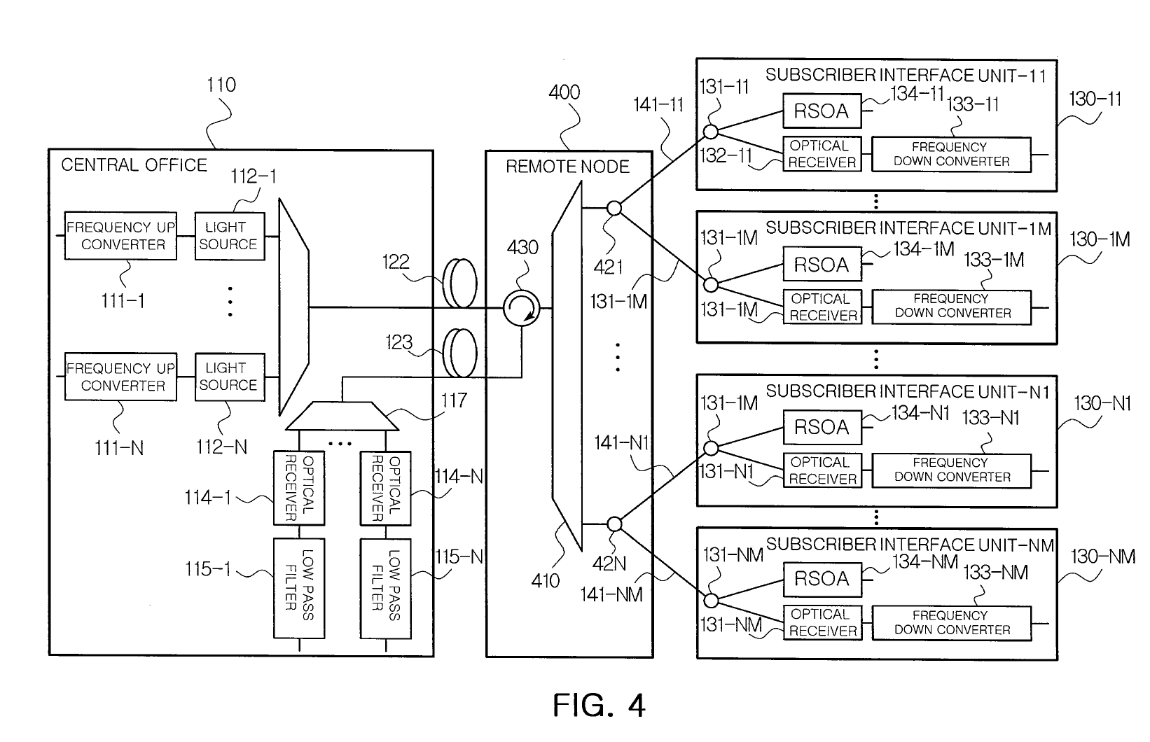

FIG. 4 is a structural view illustrating a loopback-type WDM-PON system according to a fourth embodiment of the present invention. In this system, a remote node 400 controls a transmission direction of a signal and accommodates a larger number of subscriber interface units.

Referring to FIG. 4, the remote node 400 further includes N splitters 421 to 42N and a circulator 430 in addition to an optical wavelength multiplexer/demultiplexer 410.

When the remote node 400 receives wavelength-multiplexed downstream optical SCM signals from the central office 110, the wavelength-multiplexed downstream optical SCM signals are transmitted to the optical wavelength multiplexer/demultiplexer 410 through the circulator 430, demultiplexed by the optical multiplexer/demultiplexer 410 into N downstream optical SCM signals, and divided into N×M downstream optical SCM signals by the N splitters 421 to 42N.

When the remote node 400 receive N×M upstream optical OOK signals from N×M subscriber interface units 130-11 to 130-NM, the N×M upstream optical OOK signals are combined according to wavelengths into N upstream optical OOK signals by the N splitters 421 to 42N, wavelength-demultiplexed by the optical wavelength multiplexer/demultiplexer 410, and transmitted to the optical demultiplexer 114 of the central office 110 through the circulator 430.

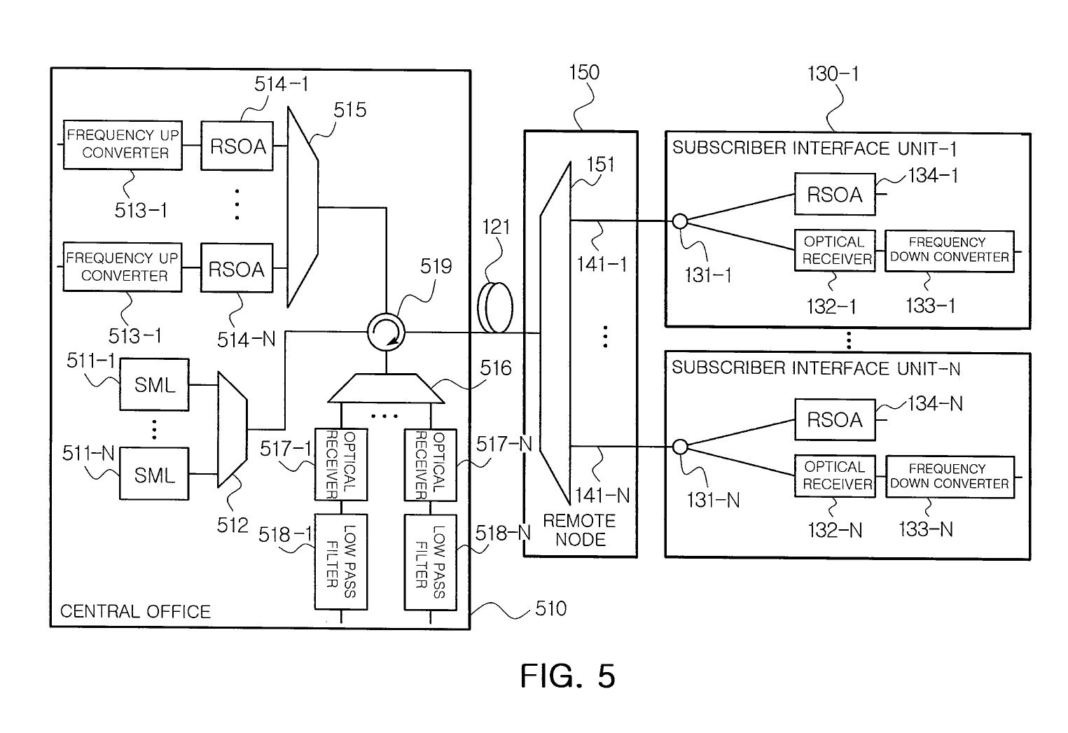

FIG. 5 is a structural view illustrating a loopback-type WDM-PON system according to a fifth embodiment of the present invention. In this system, downstream optical SCM signals are generated by using RSOAs.

Referring to FIG. 5, a central office 500 N single mode lasers (SMLs) 511-1 to 511-N, an optical multiplexer 512, N frequency up converts 513-1 to 513-N, N RSOAs 514-1 to 514-N, an optical wavelength multiplexer/demultiplexer 515, an optical demultiplexer 516, N optical receivers 517-1 to 517-N, N low pass filters 518-1 to 518-N, and a circulator 519.

The N SMLs 511-1 to 511-N generate seed lights corresponding to each of the N RSOAs 514-1 to 514-N. The optical wavelength multiplexer 512 multiplexes and transmits the N seed lights to the N RSOAs 514-1 to 514-N.

The N frequency up converters 513-1 to 513-N convert downstream baseband signals to downstream SCM signals. The N RSOAs 514-1 to 514-N are provided with the seed lights from the SMLs 511-1 to 511-N through the optical wavelength multiplexer 512 and modulates the downstream SCM signals to downstream optical SCM signals by using the seed lights.

The optical wavelength multiplexer/demultiplexer 515 wavelength-demultiplexes and divides the wavelength-multiplexed seed lights transmitted from the optical wavelength multiplexer 512 into N seed lights and transmits the divided seed lights to each of the N RSOAs 514-1 to 514-N, or multiplexes and transmits the N downstream optical SCM signals transmitted from the N RSOAs 514-1 to 514-N to the circulator 519.

The optical wavelength demultiplexer 516 divides the N upstream optical OOK signals transmitted from the circulator 519 according to wavelengths to transmit the divided signal to each of the N optical receivers 517-1 to 517-N. Each of the optical receivers 517-1 to 517-N converts the input upstream optical OOK signal into an upstream OOK signal. The low pass filters 518-1 to 518-N remove SCM signal components remaining in the upstream OOK signals.

The circulator 519 transmits the seed light sources transmitted from the optical wavelength multiplexer 512 to the optical wavelength multiplexer/demultiplexer 515, transmits the downstream optical SCM signals transmitted from the optical wavelength multiplexer/demultiplexer 515 to the remote node 150, and transmits the upstream optical OOK signals transmitted from the remote node 150 to the optical wavelength demultiplexer 516.

According to the current embodiment illustrated in FIG. 5, the central office 500 provides the seed lights to the optical wavelength multiplexer/demultiplexer 515 through the second optical wavelength multiplexer 512. However, the central office 500 may implement the seed light sources as a spectrum-sliced broad band light or a wavelength-multiplexed multi-wavelength light to provide the seed light to the optical wavelength multiplexer/demultiplexer 515 without the second optical wavelength multiplexer 512 as needed.

As described above, the WDM-PON system illustrated in FIG. 5 can generate the downstream optical signals as in the WDM-PON systems illustrated in FIGS. 1 to 4. Specifically, according to the present invention, the SCM signals can be converted into the optical signals in various methods, and any method of converting electric signals into optical signals can be applied to the present invention.

In addition, the WDM-PON system illustrated in FIG. 5 can be modified in various manners as illustrated in FIGS. 2 to 4.

Accordingly, the loopback-type WDM-PON system uses the SCM as the downstream optical signal and generates the upstream optical signal by using the optical SCM signal as the seed light, so that an additional signal leveling operation is not needed for this downstream optical signal remodulation scheme. Significant transmission performance deterioration does not occur at low incident light power at which the RSOA is not operated in a gain saturation region, and accordingly a more power budget margin of a network can be achieved. Therefore, the more stable network can be constructed.

In addition, an expensive apparatus such as a Mach-Zehnder modulator is not needed unlike in the conventional art, so that the loopback-type WDM-PON system can be implemented at lower costs.

While the present invention has been shown and described in connection with the exemplary embodiments, it will be apparent to those skilled in the art that modifications and variations can be made without departing from the spirit and scope of the invention as defined by the appended claims.

What is claimed is:

1. A loopback-type WDM-PON (wavelength division multiplexing passive optical network) system comprising:
a central office converting downstream signals into downstream optical SCM (subcarrier multiplexed) signals to wavelength-multiplex and transmit the downstream SCM signals, or receiving and demodulating upstream optical OOK (on-off keying) signals to convert the upstream optical OOK signals into upstream signals;
a remote node receiving the wavelength-multiplexed downstream optical SCM signals and wavelength-demultiplexing and transmitting the downstream optical SCM signals, or receiving the upstream optical OOK signals and wavelength-multiplexing and transmitting the upstream optical OOK signals; and
subscriber interface units dividing the downstream optical SCM signals into first and second optical SCM signals, converting the first optical SCM signals into downstream signals, and modulating the upstream signals to the optical OOK signals by using the second optical SCM signals to transmit the optical OOK signals to the remote node.

2. The system of claim 1, wherein the central office comprises:
frequency up converters converting the downstream signals into downstream SCM signals;
light sources modulating the downstream SCM signals into the downstream optical SCM signals having unique wavelengths;
a first optical wavelength multiplexer wavelength-multiplexing and transmitting the downstream optical SCM signals;
a first optical wavelength demultiplexer wavelength-demultiplexing the wavelength-multiplexed upstream optical OOK signals into the upstream optical OOK signals;
first optical receivers demodulating the upstream optical OOK signals into the upstream signals; and
first low pass filters removing SCM signal components remaining in the upstream signals.

3. The system of claim 2, wherein the light sources are SML sources.

4. The system of claim 2, wherein the light sources are implemented individually or in an integrated array type.

5. The system of claim 2, wherein the light sources are implemented as optical modules packaged in a transmitter optical CAN type.

6. The system of claim 2, wherein the central office further comprises a first circulator transmitting the wavelength-multiplexed downstream optical SCM signal to the remote node and transmitting the multiplexed upstream optical OOK signal to the optical wavelength demultiplexer.

7. The system of claim 1, wherein the central office comprises:
single mode laser diodes generating seed lights having unique wavelengths;
a second optical wavelength multiplexer wavelength-multiplexing and outputting the seed lights;
second frequency up converters converting the downstream signals into downstream SCM signals;
second RSOAs (reflective semiconductor optical amplifiers) receiving the seed lights and modulating the downstream SCM signals to the downstream optical SCM signals having unique wavelengths;
a second optical wavelength multiplexer/demultiplexer wavelength-demultiplexing the wavelength-multiplexed seed lights so as to be provided to the RSOAs, and wavelength-multiplexing and transmitting the downstream optical SCM signals;
a second optical wavelength demultiplexer wavelength-demultiplexing the wavelength-multiplexed upstream optical OOK signals into the upstream optical OOK signals;
a plurality of second optical receivers demodulating the upstream optical OOK signals into the upstream signals; and
a plurality of second low pass filters removing SCM signal components remaining at the upstream signals.

8. The system of claim 7, wherein the central office further comprises a second circulator transmitting the wavelength-multiplexed downstream optical SCM signal to the remote node and transmitting the wavelength-multiplexed upstream optical OOK signals to the optical wavelength demultiplexer.

9. The system of claim 1, wherein the central office comprises:
light sources generating spectrum-sliced broad band lights as seed lights;
second frequency up converters converting the downstream signals into the downstream SCM signals;
second RSOAs receiving the seed lights and modulating the downstream SCM signals to the downstream optical SCM signals having unique wavelengths;
second optical wavelength multiplexer/demultiplexer wavelength-demultiplexing and providing the seed lights to the RSOAs and wavelength-multiplexing and transmitting the downstream optical SCM signals;
a second optical wavelength demultiplexer wavelength-demultiplexing the wavelength-multiplexed upstream optical OOK signal to the upstream optical OOK signals;
a plurality of second optical receivers demodulating the upstream optical OOK signals to the upstream signals; and
a plurality of second low pass filters removing SCM signal components remaining in the upstream signals.

10. The system of claim 1, wherein the central office comprises:
light sources generating wavelength-multiplexed multi-wavelength lights as the seed light sources;
second frequency up converters converting the downstream signals into downstream SCM signals;
second RSOAs receiving the seed lights and modulating the downstream SCM signals to the downstream optical SCM signals having unique wavelengths;
second optical wavelength multiplexer/demultiplexer wavelength-demultiplexing and providing the seed lights to the RSOAs and wavelength-multiplexing and transmitting the downstream optical SCM signals;
a second optical wavelength demultiplexer wavelength-demultiplexing the wavelength-multiplexed upstream optical OOK signal to the upstream optical OOK signals;
a plurality of second optical receivers demodulating the upstream optical OOK signals to the upstream signals; and
a plurality of second low pass filters removing SCM signal components remaining in the upstream signals.

11. The system of claim 1, wherein the remote node comprises an optical wavelength multiplexer/demultiplexer wavelength-demultiplexing the wavelength-multiplexed downstream optical SCM signal to the downstream optical SCM signals to transmit the downstream optical SCM signals to the subscriber interface units, and wavelength-multiplexing and transmitting the upstream optical OOK signals to the central office.

12. The system of claim 11, wherein the remote node further comprises a third circulator transmitting the wavelength-multiplexed downstream optical SCM signal to the optical wavelength multiplexer/demultiplexer, or transmitting the wavelength-multiplexed upstream optical OOK signal to the central office.

13. The system of claim 11, wherein the remote node further comprises first splitters dividing and transmitting the downstream optical SCM signals output from the optical wavelength multiplexer/demultiplexer to the subscriber interfaces, or combining the upstream optical OOK signals output from the subscriber interface units according to wavelengths to transmit the combined upstream optical OOK signals to the optical wavelength multiplexer/demultiplexer.

14. The system of claim 1, wherein each of the subscriber interface units comprises:
a second coupler dividing the downstream optical SCM signal transmitted from the remote node into first and second optical SCM signals;
a second optical receiver converting the first optical SCM signal to an SCM signal;
a frequency down converter converting the SCM signal to the downstream signal; and
an RSOA generating the upstream signal by using the second optical SCM signal as the seed light to transmit the upstream signal to the remote node.

15. The system of claim 1, further comprising:
a first optical fiber transmitting the wavelength-multiplexed downstream optical SCM signal from the central office to the remote node, and transmitting the multiplexed upstream optical OOK signal from the remote node to the central office; and
second optical fibers transmitting the downstream optical SCM signals from the remote node to the subscriber interface units, and transmitting the downstream optical SCM signals from the subscriber interface units to the remote node.

16. The system of claim 12 or 15, wherein the first optical fiber comprises:
a downstream optical fiber transmitting the wavelength-multiplexed downstream optical SCM signal from the central office to the remote node; and
an upstream optical fiber transmitting the wavelength-multiplexed upstream optical OOK signal from the remote node to the central office.

17. A loopback-type WDM-PON system including a central office, a remote node, and subscriber interface units, wherein the subscriber interface unit comprises:
a coupler dividing a downstream optical SCM signal transmitted from the remote node into first and second optical SCM signals;
an optical receiver converting the first optical SCM signal to an SCM signal;
a frequency down converter converting the SCM signal to a downstream signal; and
an RSOA generating an upstream signal by using the second optical SCM signal as a seed light.
